(19) United States
(12) Patent Application Publication
(10) Pub. No.: US 2003/0067274 A1
(43) Pub. Date: Apr. 10, 2003

(54) EL lamp emitting encoded light

(75) Inventor: Edward L. Kinnally, Gilbert, AZ (US)

Correspondence Address: Paul F. Wille, DUREL CORPORATION, 2225 West Chandler Boulevard, Chandler, AZ, 85224, US

(73) Assignee: Durel Corporation

(21) Appl. No.: 09/975,040

(22) Filed: Oct. 9, 2001

(51) Int. Cl. G09G 3/10

(52) U.S. Cl. 315/169.3

(57) ABSTRACT

At least one layer of cascading material overlying an EL lamp converts the light emitted by the EL lamp into infrared light. The EL lamp is supported within in a container transparent to at least infrared light, along with at least one battery and an inverter to provide power for the lamp in portable applications. The lamp is rolled to form a cylinder and fits within the inside diameter of the container. The lamp can be turned on or off by means of a switch interrupting current from a battery or to the lamp. Light is encoded in accordance with a series of pulses from a pulse source, preferably controlled by a microprocessor programmed with more than one code.

### CROSS-REFERENCE TO RELATED APPLICATION

This application relates to Application No. ______, filed the same day as this application, entitled Infrared Emitting EL Lamp, and assigned to the assignee of this invention. The contents of said other application are hereby incorporated by reference.

### BACKGROUND OF THE INVENTION

This invention relates to light sources for emitting light encoded with information and, in particular, to an electroluminescent (EL) source of encoded light emission.

Using light to send messages is an ancient and varied art. Modern broad band optical fiber communication sources use sophisticated materials and error detection techniques but, at their core, simply turn a light on or off as in ancient times. Yet a need remains for new encoded light sources, particularly in applications where the light source must be highly mobile, rugged, glare-free, and inexpensive or disposable.

Low level light sources are used wherever there is desired sufficient light for mobility but not acuity, such as night lights and emergency lights, or where a light source is viewed directly rather than used as a source of illumination, such as marker lights. A popular source of such lighting is chemiluminescent sticks, in which two or more chemicals are mixed to produce a photochemical reaction. The container for the mixed chemicals acts as a tubular lamp. Problems with chemiluminescent sticks include low luminance, short life (defined as the time to half of initial luminance), sensitivity to jarring, safe disposal of the materials, and the inability to turn the light off after the reaction is started. Chemiluminescent sticks typically have a life of approximately twenty minutes but will glow weakly for several hours.

An alternative to a chemiluminescent stick is an “electronic GloStick” as sold by the Night Vision Equipment Company. This device includes light emitting diodes (LEDs) in a plastic tube for scattering light. LEDs are a point source of light and it is difficult to convert this light into a large, glare-free, luminous area. Another alternative to a chemiluminescent stick is a tubular electroluminescent lamp such as disclosed in U.S. Pat. No. 6,075,322 (Pauly). An EL lamp in the form of a flat sheet is rolled into a cylinder with the luminous side facing outward and stored in a transparent tube containing batteries and an inverter for driving the lamp. The EL lamp includes a dielectric layer between two conductive electrodes, one of which is transparent. The dielectric layer includes a phosphor powder or there is a separate layer of phosphor powder adjacent the dielectric layer. The phosphor powder emits light in the presence of a strong electric field, using very little current. An EL lamp requires high voltage, alternating current but consumes very little power, even including the current drawn by an inverter for driving an EL lamp, and consumes much less power than bright LEDs.

A beacon type of marker using a laser diode to produce infrared light is disclosed in U.S. Pat. No. 5,299,227 (Rose). The transmission from the laser is modulated to provide an encoded signal enabling one to identify a person near the marker as either friend or foe.

There remains a need in the art for a low power, glare-free, long life, encoded light source that produces infrared or visible radiation.

In view of the foregoing, it is therefore an object of the invention to provide an EL light source that emits encoded light.

Another object of the invention is to provide an EL light source that emits encoded infrared light in a band that matches the near infrared sensitivity of night vision devices.

A further object of the invention is to provide an encoded light source that has a life of more than several hundred hours.

### SUMMARY OF THE INVENTION

The foregoing objects are achieved in this invention wherein a light source for emitting encoded light includes an EL lamp, a driver coupled to the EL lamp for powering the EL lamp, the driver having the capability of being switched on or off, and a source of pulses coupled to the driver for turning the driver on or off, thereby encoding the light from the EL lamp. The EL lamp emits visible or infrared light. In accordance with another aspect of the invention, light from the source is segmented along at least one dimension of the source.

### BRIEF DESCRIPTION OF THE DRAWINGS

A more complete understanding of the invention can be obtained by considering the following detailed description in conjunction with the accompanying drawings, in which:

FIG. 1 is a perspective view of an light source constructed in accordance with the invention;

FIG. 2 is a cross-section of an EL lamp constructed in accordance with a preferred embodiment of the invention; and

FIG. 3 is a block diagram of a driver for encoding light emission from an EL lamp.

### DETAILED DESCRIPTION OF THE INVENTION

FIG. 1 is a perspective view of a light source constructed in accordance with the invention. Light source 10 includes cylindrical container 11 that is transparent or at least translucent. One end of container 11 is closed with fitting 12 that preferably includes tab 14 having an eyelet or other mechanism for hanging or fastening source 10 to a support. Fitting 12 is preferably sealed to container 11 to form an essentially integral device. The open end of container 11 is preferably closed by cap 16 that engages threads on the open end of the container. Suitable sealing means (not shown) provides a water tight closure between cap 16 and cylinder 11.

Inside container 11, EL lamp 20 is curved to follow the curvature of the inside diameter of the container and curved such that the light emitting side is facing out. Within EL lamp 20, one or more batteries, such as battery 17, are stored. The batteries provide power for circuit board 18, which includes an inverter for driving lamp 20. The batteries are electrically coupled to circuit board 18, which is also electrically coupled to lamp 20. The batteries can be physically isolated from lamp 20 by suitable cushion strips (not shown) and the inverter can be glued or otherwise fastened to fitting 12 for increased ruggedness. The circuitry on board 18 is turned on by a switch (not shown), which can conveniently be included in cap 16. The particular construction of container 11, fitting 12, and cap 16 depends upon intended use and cost, among other factors.

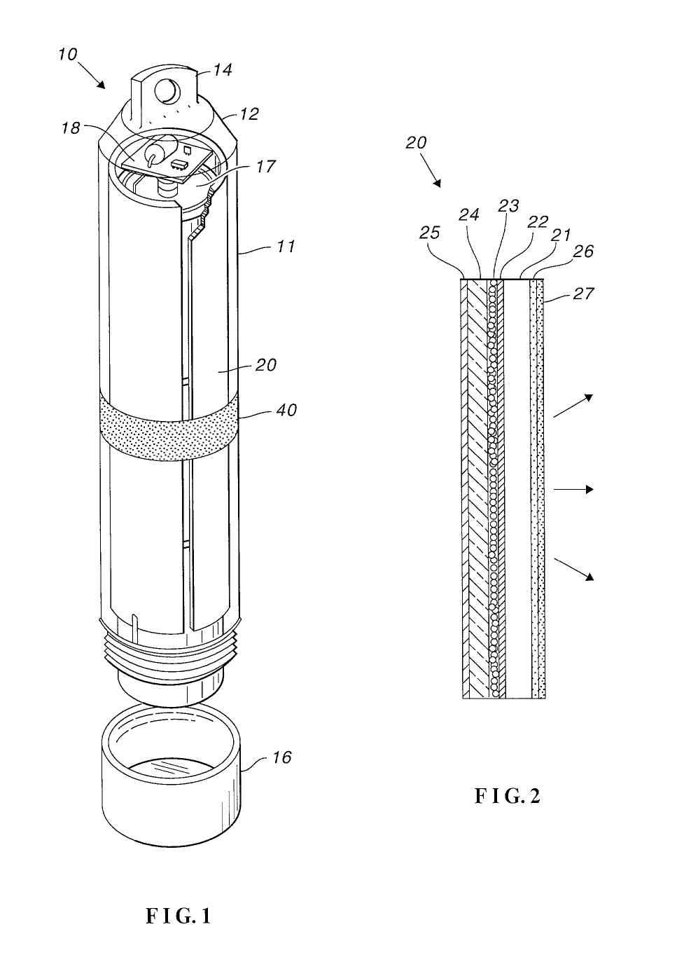

FIG. 2 is a cross-section of an infrared light source. The several layers shown are not in proportion or to scale. EL lamp 20 includes transparent substrate 21 of polyester or polycarbonate material. Transparent electrode 22 overlies substrate 21 and includes indium tin oxide, indium oxide, or other transparent, conductive material. Phosphor layer 23 overlies electrode 22 and dielectric layer 24 overlies the phosphor layer. Overlying dielectric layer 24 is conductive layer 25 containing conductive particles such as silver or carbon in a resin binder. Conductive layer 25 is the rear electrode and is preferably somewhat reflective. A conductive sheet, such as aluminum foil, or a screen printed layer can be used as the rear electrode. A rear insulating layer (not shown) can be added if desired.

An EL lamp constructed as described emits visible light. A cascading material is necessary to convert the visible light into infrared. EL lamp 20 was overprinted with cascading dye layers to convert light emitted by phosphor layer 23 into infrared light. If phosphor layer 23 emits orange light, a single cascading dye layer is sufficient. Preferably, phosphor layer 23 emits green light. A phosphor emitting blue-green or blue light can be used but a greater shift in wavelength is required, which is more difficult.

During operation, an alternating current is applied to electrodes 22 and 25, causing a minute current to flow between the electrodes, through the lamp, causing the phosphor in layer 23 to emit green light. The light passes through red dye layer 26, where most of the green light is converted into red light, and through infrared dye layer 27, where most of the red light is converted into infrared light.

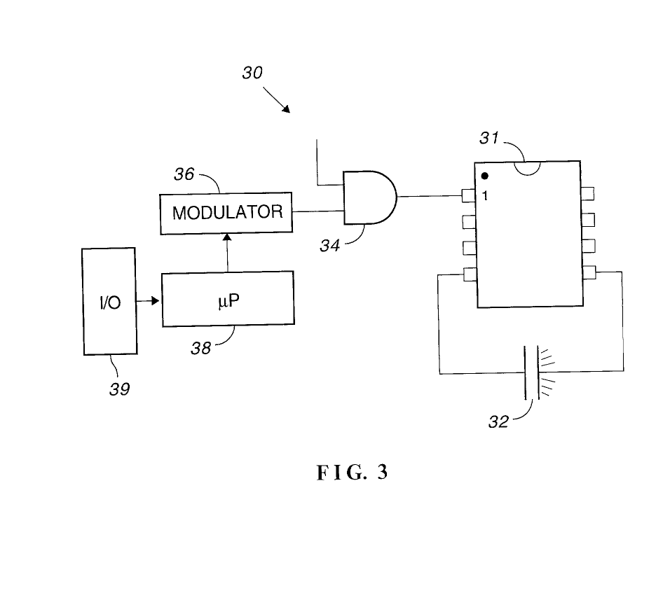

FIG. 3 is a block diagram of a circuit for encoding the light from an EL lamp in accordance with the invention. Encoder 30 includes driver 31 for supplying power to EL lamp 32. Several commercially available driver circuits, such as Supertex SP4405, include an enable pin for switching an EL lamp on or off. In FIG. 3, pin 1, marked with a dot, is an enable pin coupled to AND gate 34. One input to AND gate 34 is coupled to an enable line, to maintain the enable function. A second input to AND gate 34 is coupled to modulator 36, which provides a stream of pulses for modulating the light from lamp 32. Modulator 36 is controlled by microprocessor 38, which receives user input via one or more switches in I/O device 39. Microprocessor 38 is programmed with several modulation codes that the user can select via I/O device 39. I/O device 39 represents, for example, a rotary switch in cap 16 (FIG. 1) coupled to logic circuitry for interfacing with microprocessor 38.

When the output from modulator 36 is high, or a logic “1”, and the first input to AND gate 34 is also high, the output of AND gate 34 is high, enabling driver 32. Conversely, when the output of modulator 36 is low, the output of AND gate 34 is low, turning off driver 31. The pulse stream from modulator 36 can be in any desired form to provide an encoded signal. The pulse width and pulse frequency are determined, in part, by the persistence of the phosphor in EL lamp 32. For visible light applications, the frequency should not be so low as to produce a noticeable flicker, e.g. below 45 Hz. For infrared applications, a lower frequency can be used.

The frequency used also depends upon ambient noise. Obviously, in a room illuminated by fluorescent lamps with magnetic ballasts, the fluorescent lamps will produce a pronounced flicker at 120 Hz, making it difficult to detect signals near this frequency.

In accordance with another aspect of the invention, light from source 10 can be segmented by blocking portions of the light emitted along the length of the source, as represented by opaque band 40 (FIG. 1). Depending upon the amount of dark space between light segments, one can use such a lamp for range estimation by whether or not the segments can be resolved by the aided or unaided human eye. The lamp or the container can be covered to produce segments.

The invention thus provides an EL light source that emits encoded light, which can be visible light or infrared light in a band that matches the near infrared sensitivity of night vision devices. An encoded light source constructed in accordance with the invention has a life of more than several hundred hours.

Having thus described the invention, it will be apparent to those of skill in the art that many modifications can be made within the scope of the invention. For example, the shape of the EL lamp is a matter of choice. The logic levels in encoder 30 can be changed to suit particular applications, e.g. a low voltage or logic “0” enables driver 30. Using the enable pin of a driver results in low voltage switching. Fixed logic, an ASIC (application specific integrated circuit), or other logic could be used instead of a microprocessor. One could interrupt the high voltage AC to an EL lamp to achieve encoding but high voltage switching devices are more complex to implement in an integrated circuit. One could interrupt the supply voltage to the driver but this requires the driver to start up and settle prior to driving an EL lamp. Although described as a beacon type of marker, additional electronics can be added to circuit board 18 to provide a transponder type of marker; i.e. a marker that responds to an interrogation signal with an encoded signal or responds to a control signal by turning on or off. If the light source must emit only infrared light, an additional layer can be added to block the small fraction of visible light that is not absorbed by the cascading dye layers. The layer can be added to the EL lamp or to the container. A segmented light source can have the segments modulated individually.

What is claimed as the invention is:

1. A encoded light source comprising;
an EL lamp;
a driver coupled to said EL lamp for powering the EL lamp; said driver having the capability of being switched on or off;
a source of pulses coupled to said driver for turning said driver on or off, thereby encoding the light from said EL lamp.

2. The light source as set forth in claim 1 wherein said EL lamp produces visible light..

3. The light source as set forth in claim 1 wherein said EL lamp produces infrared light.

4. The light source as set forth in claim 1 and further including a container at least partially enclosing said EL lamp.

5. The light source as set forth in claim 4 wherein said container includes an opaque band for dividing the light into two segments.

6. The light source as set forth in claim 4 wherein said lamp includes an opaque band for dividing the light into two segments.

7. The light source as set forth in claim 1 and further including a microprocessor coupled to said source and programmed to include more than one modulation code.

8. A portable light source comprising:
an EL lamp;
a driver coupled to said lamp;
a container at least partially enclosing said EL lamp;
an opaque band around said EL lamp for dividing the light from the EL lamp into at least two segments.

9. The portable infrared light source as set forth in claim 8 and further including a switch for selectively turning said lamp on or off.

10. The portable infrared light source as set forth in claim 9 wherein said EL lamp is curved to fit within said container.
